(19) United States
(12) Patent Application Publication
(10) Pub. No.: US 2012/0275561 A1
(43) Pub. Date: Nov. 1, 2012

(54) METHODS AND APPARATUS FOR CT SMOOTHING TO REDUCE ARTIFACTS

(76) Inventors: Jianying Li, New Berlin, WI (US); Jiang Hsieh, Brookfield, WI (US)

(21) Appl. No.: 13/545,743

(22) Filed: Jul. 10, 2012

Related U.S. Application Data
(62) Division of application No. 10/798,650, filed on Mar. 11, 2004, now abandoned.

(51) Int. Cl. G06K 9/44; H05G 1/60

(52) U.S. Cl. 378/19; 382/131

(57) ABSTRACT

A method for reconstructing an image of an object includes scanning an object using a computed tomographic (CT) imaging apparatus to acquire projections of the object. A set of thresholds are determined utilizing the projections, and selected smoothing kernels are associated with the thresholds. The method further includes utilizing the smoothing kernels and the projections to produce smoothed projections in accordance with the thresholds and filtering and backprojecting the smoothed projections to generate an image of the object.

### BACKGROUND OF THE INVENTION

This invention relates generally to methods and apparatus for CT imaging of objects, and more particularly to methods and apparatus for reducing streaking artifacts and noise in CT images while avoiding resolution loss.

At least one adaptive pre-smoothing method has been proposed to reduce streaking artifacts and noise in CT images while, at the same time, minimizing resolution loss. This method primarily comprises a one-dimensional pre-smoothing algorithm, in part due to limitations imposed by reconstruction hardware at the time the algorithm was developed. Also, for extremely low signal CT imaging, digitization errors can occur in the data acquisition. These errors were made non-linear by logarithmic operations. Therefore, while the known pre-smoothing method generally performs well in most cases, artifacts may be introduced in extremely low-signal CT cases. For example, artifacts may be introduced when imaging pairs of dense materials, for example, shoulder bones. Corrections tend to increase the artifacts as a result of clipping used in the algorithm to avoid logarithmic singularities. Also, the non-linear nature of one-dimensional corrections can result in residual streaks near edges of images.

### BRIEF DESCRIPTION OF THE INVENTION

Some aspects of the present invention therefore provide a method for reconstructing an image of an object. The method includes scanning an object using a computed tomographic (CT) imaging apparatus to acquire projections of the object. A set of thresholds are determined utilizing the projections, and selected smoothing kernels are associated with the thresholds. The method further includes utilizing the smoothing kernels and the projections to produce smoothed projections in accordance with the thresholds and filtering and backprojecting the smoothed projections to generate an image of the object.

In another aspect, the present invention provides a method for reconstructing an image of an object. The method includes scanning an object using a computed tomographic (CT) imaging apparatus to acquire projections of the object. The method further includes producing temporary values utilizing the acquired projections. Producing temporary values includes the production of prepped projections to a point prior to a logarithmic operation. Shading reduction (SR) factors are determined as a function of the temporary values, and the prepped projections are conditionally multiplied using the SR factors. The prepped projections are smoothed in accordance with pre-selected thresholds and final projections are determined utilizing unsmoothed prepped projections and smoothed prepped projections. The final projections are filtered and backprojected to generate an image of the object.

In yet another aspect, the present invention provides a CT imaging apparatus that is configured to scan an object to acquire projections of the object, determine a set of thresholds utilizing the projections, associate selected smoothing kernels with said thresholds, utilize the smoothing kernels and the projections to produce smoothed projections in accordance with the thresholds, and filter and backproject the smoothed projections to generate an image of the object.

In still other aspects, the present invention provides a CT imaging apparatus that is configured to scan an object to acquire projections of the object and produce temporary values utilizing the acquired projections, wherein the production of temporary values includes the production of prepped projections to a point prior to a logarithmic operation. The CT imaging apparatus is further configured to determine shading reduction (SR) factors as a function of the temporary values, conditionally multiply the prepped projections using the SR factors, and smooth the prepped projections in accordance with pre-selected thresholds. The CT imaging apparatus is also configured to determine final projections utilizing unsmoothed prepped projections and smoothed prepped projections and filter and backproject the final projections to generate an image of the object.

In yet additional aspects, the present invention provides a computer-readable medium having instructions thereon configured to instruct a computer to determine a set of thresholds utilizing projections obtained by scanning an object, associate selected smoothing kernels with the thresholds, utilize smoothing kernels and the projections to produce smoothed projections in accordance with the thresholds, and filter and backproject the smoothed projections to generate an image of the object.

In still other aspects, the present invention provides a computer-readable medium having instructions thereon configured to instruct a computer to produce temporary values utilizing projections acquired from a scan of an object. The production of the temporary values includes the production of prepped projections to a point prior to a logarithmic operation. The instructions also instruct the computer to determine shading reduction (SR) factors as a function of the temporary values, conditionally multiply the prepped projections using the SR factors, smooth the prepped projections in accordance with pre-selected thresholds, determine final projections utilizing unsmoothed prepped projections and smoothed prepped projections, and filter and backproject the final projections to generate an image of the object.

It will be appreciated that configurations of the present invention are effective in producing images having reduced artifacts, particularly when imaging pairs of dense materials. In addition, residual streaks near edges of images are reduced.

### BRIEF DESCRIPTION OF THE DRAWINGS

FIG. 1 is a pictorial view of a configuration of a CT imaging system.

FIG. 2 is a block schematic diagram of the system illustrated in FIG. 1.

FIG. 3 is a flow chart representative of a configuration of a method of the present invention for CT smoothing to reduce artifacts.

FIG. 4 is a graph of a shading reduction (SR) factor as a function of the prepped projection value in one configuration of the present invention.

FIG. 5 is an example of an image of a phantom produced by a configuration of the present invention showing a reduction in artifacts as compared to FIG. 6.

FIG. 6 is an image of the same phantom shown in FIG. 5, the image of FIG. 6 having been produced by a prior art method.

FIG. 7 is another example of an image produced by a configuration of the present invention showing a reduction in artifacts as compared to FIG. 8.

FIG. 8 is an image of the same object shown in FIG. 5, the image of FIG. 8 having been produced by a prior art method.

### DETAILED DESCRIPTION OF THE INVENTION

Example embodiments of systems that facilitate imaging of objects are described below in detail. Technical effects of the systems and processes described herein include at least the facilitating the display of an object with reduced residual streak artifacts.

In some known CT imaging system configurations, an x-ray source projects a fan-shaped beam which is collimated to lie within an X-Y plane of a Cartesian coordinate system and generally referred to as an “imaging plane”. The x-ray beam passes through an object being imaged, such as a patient. The beam, after being attenuated by the object, impinges upon an array of radiation detectors. The intensity of the attenuated radiation beam received at the detector array is dependent upon the attenuation of an x-ray beam by the object. Each detector element of the array produces a separate electrical signal that is a measurement of the beam intensity at the detector location. The intensity measurements from all the detectors are acquired separately to produce a transmission profile.

In third generation CT systems, the x-ray source and the detector array are rotated with a gantry within the imaging plane and around the object to be imaged such that the angle at which the x-ray beam intersects the object constantly changes. A group of x-ray attenuation measurements, i.e., projection data, from the detector array at one gantry angle is referred to as a “view”. A “scan” of the object comprises a set of views made at different gantry angles, or view angles, during one revolution of the x-ray source and detector.

In an axial scan, the projection data is processed to construct an image that corresponds to a two-dimensional slice taken through the object. One method for reconstructing an image from a set of projection data is referred to in the art as the filtered backprojection technique. This process converts the attenuation measurements from a scan into integers called “CT numbers” or “Hounsfield units” (HU), which are used to control the brightness of a corresponding pixel on a cathode ray tube display.

To reduce the total scan time, a “helical” scan may be performed. To perform a “helical” scan, the patient is moved while the data for the prescribed number of slices is acquired. Such a system generates a single helix from a fan beam helical scan. The helix mapped out by the fan beam yields projection data from which images in each prescribed slice may be reconstructed.

Reconstruction algorithms for helical scanning typically use helical weighing algorithms that weight the collected data as a function of view angle and detector channel index. Specifically, prior to a filtered backprojection process, the data is weighted according to a helical weighing factor, which is a function of both the gantry angle and detector angle. The weighted data is then processed to generate CT numbers and to construct an image that corresponds to a two-dimensional slice taken through the object.

To further reduce the total acquisition time, multi-slice CT has been introduced. In multi-slice CT, multiple rows of projection data are acquired simultaneously at any time instant. When combined with helical scan mode, the system generates a single helix of cone beam projection data. Similar to the single slice helical, weighting scheme, a method can be derived to multiply the weight with the projection data prior to the filtered backprojection algorithm.

As used herein, an element or step recited in the singular and proceeded with the word “a” or “an” should be understood as not excluding plural said elements or steps, unless such exclusion is explicitly recited. Furthermore, references to “one embodiment” of the present invention are not intended to be interpreted as excluding the existence of additional embodiments that also incorporate the recited features.

Also as used herein, the phrase “reconstructing an image” is not intended to exclude embodiments of the present invention in which data representing an image is generated but a viewable image is not. However, many embodiments generate (or are configured to generate) at least one viewable image.

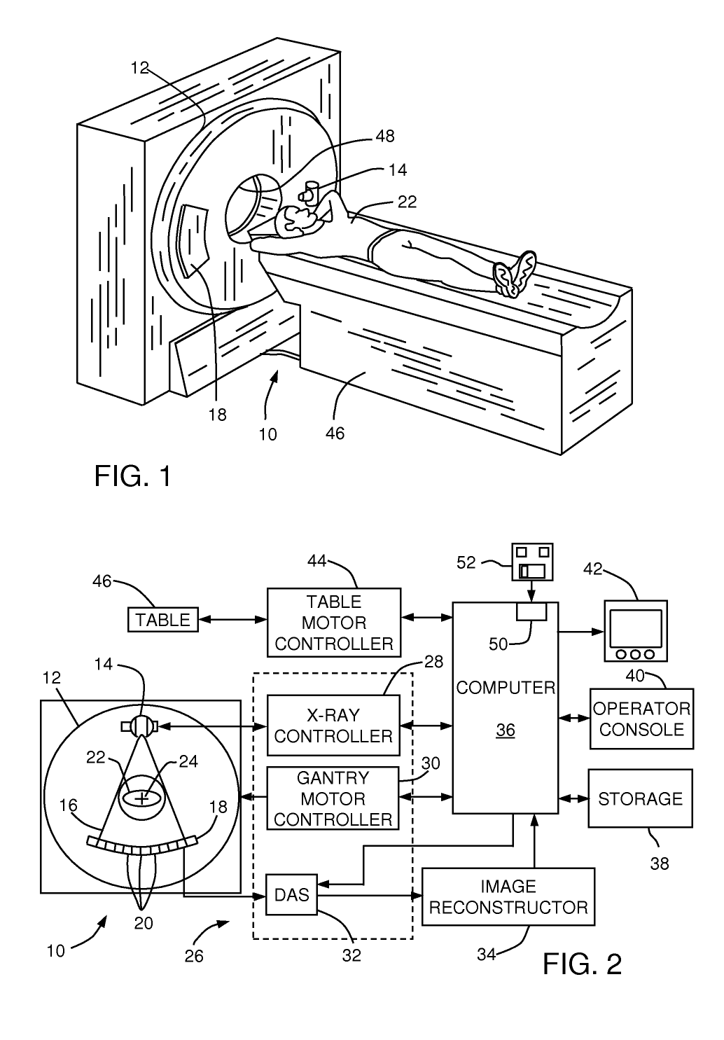

Referring to FIGS. 1 and 2, a multi-slice scanning imaging system, for example, a Computed Tomography (CT) imaging system 10, is shown as including a gantry 12 representative of a “third generation” CT imaging system. Gantry 12 has an x-ray tube 14 (also called x-ray source 14 herein) that projects a beam of x-rays 16 toward a detector array 18 on the opposite side of gantry 12. Detector array 18 is formed by a plurality of detector rows (not shown) including a plurality of detector elements 20 which together sense the projected x-rays that pass through an object, such as a medical patient 22 between array 18 and source 14. Each detector element 20 produces an electrical signal that represents the intensity of an impinging x-ray beam and hence can be used to estimate the attenuation of the beam as it passes through object or patient 22. During a scan to acquire x-ray projection data, gantry 12 and the components mounted therein rotate about a center of rotation 24. FIG. 2 shows only a single row of detector elements 20 (i.e., a detector row). However, multi-slice detector array 18 includes a plurality of parallel detector rows of detector elements 20 such that projection data corresponding to a plurality of quasi-parallel or parallel slices can be acquired simultaneously during a scan.

Rotation of components on gantry 12 and the operation of x-ray source 14 are governed by a control mechanism 26 of CT system 10. Control mechanism 26 includes an x-ray controller 28 that provides power and timing signals to x-ray source 14 and a gantry motor controller 30 that controls the rotational speed and position of components on gantry 12. A data acquisition system (DAS) 32 in control mechanism 26 samples analog data from detector elements 20 and converts the data to digital signals for subsequent processing. An image reconstructor 34 receives sampled and digitized x-ray data from DAS 32 and performs high-speed image reconstruction. The reconstructed image is applied as an input to a computer 36, which stores the image in a storage device 38. Image reconstructor 34 can be specialized hardware or computer programs executing on computer 36.

Computer 36 also receives commands and scanning parameters from an operator via console 40 that has a keyboard. An associated cathode ray tube display 42 or other suitable type of display device allows the operator to observe the reconstructed image and other data from computer 36. The operator supplied commands and parameters are used by computer 36 to provide control signals and information to DAS 32, x-ray controller 28, and gantry motor controller 30. In addition, computer 36 operates a table motor controller 44, which controls a motorized table 46 to position patient 22 in gantry 12. Particularly, table 46 moves portions of patient 22 through gantry opening 48.

In one embodiment, computer 36 includes a device 50, for example, a floppy disk drive, CD-ROM drive, DVD drive, magnetic optical disk (MOD) device, or any other digital device including a network connecting device such as an Ethernet device for reading instructions and/or data from a computer-readable medium 52, such as a floppy disk, a CD-ROM, a DVD or another digital source such as a network or the Internet, as well as yet to be developed digital means. In another embodiment, computer 36 executes instructions stored in firmware (not shown). Computer 36 is programmed to perform functions described herein, and as used herein, the term computer is not limited to just those integrated circuits referred to in the art as computers, but broadly refers to computers, processors, microcontrollers, microcomputers, programmable logic controllers, application specific integrated circuits, and other programmable circuits, and these terms are used interchangeably herein. Although the specific embodiment mentioned above refers to a third generation CT system, the methods described herein equally apply to fourth generation CT systems (stationary detector—rotating x-ray source) and fifth generation CT systems (stationary detector and x-ray source). Additionally, it is contemplated that the benefits of the invention accrue to imaging modalities other than CT. Additionally, although the herein described methods and apparatus are described in a medical setting, it is contemplated that the benefits of the invention accrue to non-medical imaging systems such as those systems typically employed in an industrial setting or a transportation setting, such as, for example, but not limited to, a baggage scanning system for an airport or other transportation center.

Some configurations of the present invention provide adaptive 3D pre-smoothing for CT to reduce shading artifacts and residual streaks. In some configurations, projections are first adjusted before clipping them at a low threshold. The adjustment can be performed either empirically or on the basis of theoretical calculations. Next, a set of thresholds are determined utilizing the projections themselves. For example, some configurations use a set of 4 thresholds, namely high, medium, low and very low. Smoothing kernels are selected and associated with the thresholds, wherein, in many configurations, a one-to-one correspondence exists between the smoothing kernels and the thresholds. To avoid over-smoothing, 3D pre-smoothing is turned on only when a threshold is triggered, for example, the triggering of lower thresholds, or the triggering of thresholds lower than an average value. Some configurations modulate the smoothing by a smoothing gain factor, which is a function of the projections themselves.

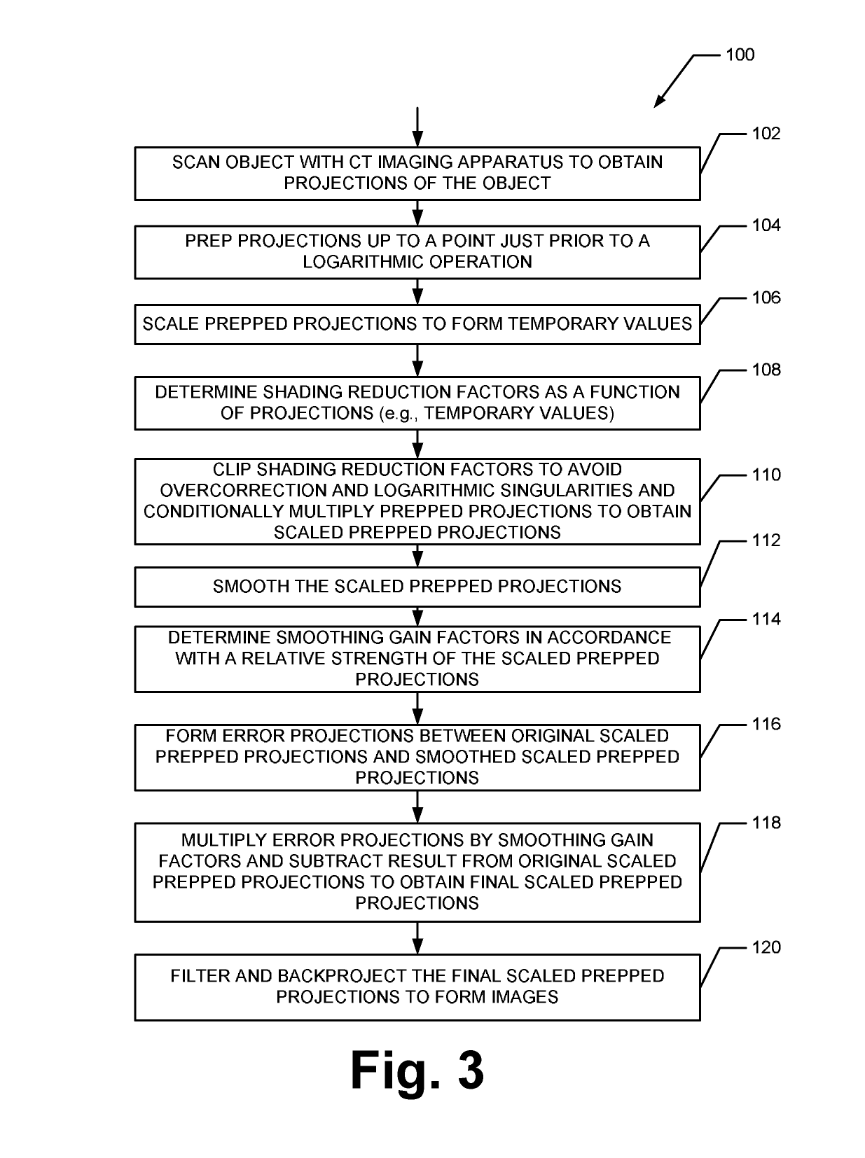

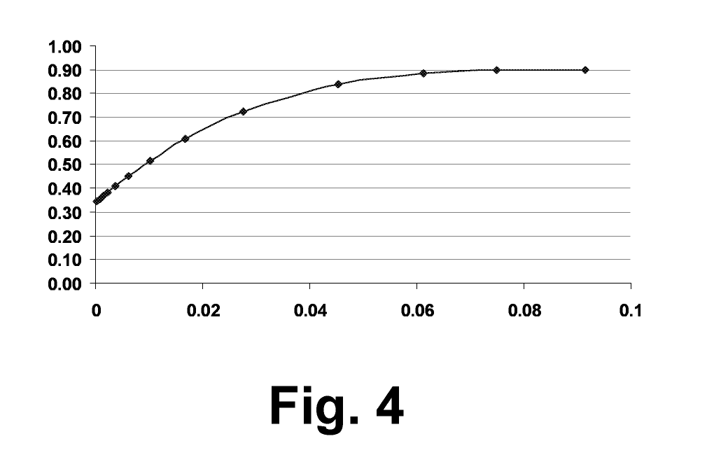

For example, in some configurations and referring to flow chart 100 of FIG. 3, a technical effect of the present invention is achieved by a person operating a CT imaging apparatus 10 to perform the steps described below.

(1) Logarithmic operations are included in known reconstruction algorithms. Thus, after scanning an object 22 with CT imaging apparatus 10 to obtain projections of the object at 102, projections are first processed (“prepped”) to a point just prior to a logarithmic operation at 104. Prepped projection PP is then multiplied by a constant (for example, 1000) as a matter of convenience to form temporary values TP at 106. Shading reduction factors (SR) are formed as a function of the projections at 108. Factors SR can be determined using theoretical calculations based upon the fact that digitization loses accuracy at low signal levels. However, in some configurations, such as the one presently being described in detail, an empirical method is used wherein smaller numbers are given a smaller weight. The SR factors are expressed as a function of the temporary values TP, for example, a polynomial expansion of the TP. One example of an expression consistent with an empirical determination is:

SR=0.34+19.75*TP−2423*TP²+1100*TP³−550*TP⁴−3530*TP⁵ (1)

The shading reduction factor above is graphically illustrated in FIG. 3.

(2) SR factors are clipped to avoid over-correction and logarithmic singularities and the prepped projections are conditionally multiplied by the clipped SR factors at 110. The value at which clipping occurs to avoid over-correction may be determined empirically. One such clipping value consistent with an empirical determination is 0.35, for example. Prepped projections PP are multiplied by the SR factors if they are below a value of exp(−9.5). The value exp(−9.5) is not critical, and other values can be used based upon the empirical observation that once a projection value is sufficiently high, errors are too small to be of concern. The scaled PP (SPP) are then clipped at a small value, e.g., exp(−14.0), to avoid logarithmic singularities. This small value is another value that can be determined empirically.

(3) In some configurations, smoothing operations are then performed on the scaled prepped projection SPP at 112. Different degrees of smoothing are used depending upon which of the pre-selected thresholds is triggered. If the SPP is below the medium threshold, 3D smoothing (row, view and channel smoothing) is also performed. In some configurations, the smoothing operation is directional and adaptive, in that it is applied in a direction in which no anatomy structure boundary is detected. In other configurations, samples that are significantly different from others are excluded from the smoothing.

(4) Smoothing gain factors SG are calculated in accordance with the relative strength of the SPP at 114:

PR=SPP/T (2)

where T is a predefined value and is generally associated with the thresholds, and GR is a smoothly decreasing function of PR, empirically determined so that different contributions are made dependent upon signal strength from 0 to 1. For example:

GR=0.999078−0.982364*PR+0.452854*PR²−0.118127*PR³+0.016640*PR⁴−0009734*PR⁵ (3)

(5) Error projections are then formed between the original (i.e., unsmoothed) SPP and the smoothed SPP at 116, and the error projections are multiplied by smoothing gain factor SG and subtracted from the original SPP to obtain final projections (e.g., final SPPs) at 118. The final SPP are then filtered and backprojected to form images at 120.

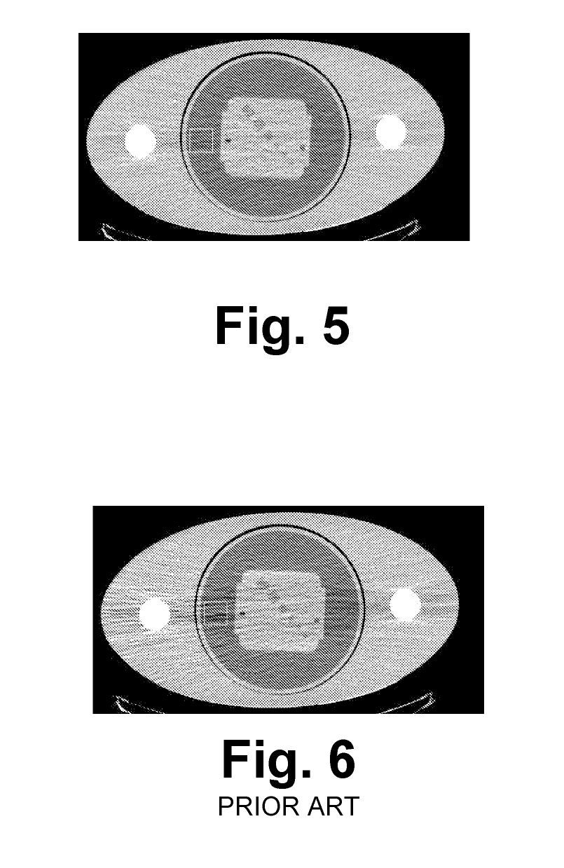

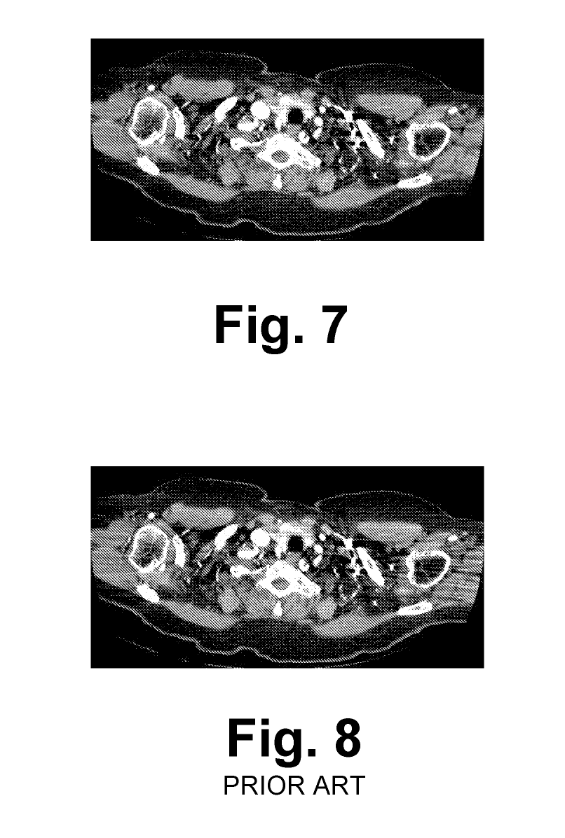

Examples showing the effectiveness of the shading artifact reduction produced by configurations of the present invention are shown in FIGS. 5 through 8. FIG. 5 shows an image of a phantom produced utilizing a configuration of the present invention that provides 3D smoothing. The reduction in shading artifacts is evident when compared with an image of the same phantom produced by a known prior art method and shown in FIG. 6. FIG. 7 is another image produced utilizing a configuration of the present invention that provides 3D smoothing. The reduction in shading artifacts near the edge of the image is evident by comparison of an image shown in FIG. 8, which is an image of the same object produced by the same known prior art method as FIG. 6. Although the images are representative of medical images and phantoms, it will be appreciated that configurations of the present invention are also applicable in non-medical applications. Such systems include those that are typically employed in an industrial setting or a transportation setting, such as, for example, but not limited to, a baggage scanning system for an airport or other transportation center.

After projections are scanned by CT imaging apparatus 10, subsequent processing and image display can be performed utilizing image reconstructor 34, computer 36, storage device 38, display 42, under control of appropriate software and/or firmware. In some configurations, however, projections obtained from a CT imaging apparatus are later processed on a separate computer programmed by instructions on a computer-readable medium 52. (The separate computer may be a “workstation.”)

While the invention has been described in terms of various specific embodiments, those skilled in the art will recognize that the invention can be practiced with modification within the spirit and scope of the claims.

1-6. (canceled)

7. A method for reconstructing an image of an object in a computed tomographic imaging system, said method comprising:
scanning an object using a computed tomographic (CT) imaging apparatus to acquire projections of the object;
producing temporary values utilizing the acquired projection comprising producing prepped projections to a point prior to a logarithmic operation;
determining shading reduction (SR) factors as a function of the temporary values;
conditionally multiplying the prepped projections using the SR factors;
smoothing the prepped projections in accordance with pre-selected thresholds;
determining final projections utilizing unsmoothed prepped projections and smoothed prepped projections; and
filtering and backprojecting the final projections to generate an image of the object in the computed tomographic imaging system.

8. A method in accordance with claim 7 wherein said producing temporary values further comprises multiplying said prepped projection values by a constant.

9. A method in accordance with claim 7 further comprising clipping said SR factors to avoid logarithmic singularities.

10. A method in accordance with claim 7 wherein said smoothing the prepped projections in accordance with pre-selected thresholds comprises using different degrees of smoothing depending upon which of the pre-selected thresholds are triggered.

11. A method in accordance with claim 7 wherein said smoothing comprises 3D smoothing.

12. A method in accordance with claim 7 wherein said smoothing is directional.

13. A method in accordance with claim 7 wherein said smoothing is adaptive.

14. A method in accordance with claim 7 further comprising determining smoothing gain factors in accordance with a relative strength of the smoothed prepped projections.

15-20. (canceled)

21. A CT imaging apparatus comprising:
a detector;
a source configured to project a beam of x-rays toward said detector; and
a computer system operatively coupled to at least one of said detector and said source, said computer system comprising:
a first module configured to scan an object to acquire projections of the object;
a second module configured to produce temporary values utilizing the acquired projections, wherein said production of temporary values includes the production of prepped projections to a point prior to a logarithmic operation;
a third module configured to determine shading reduction (SR) factors as a function of the temporary values;
a fourth module configured to conditionally multiply the prepped projections using the SR factors;
a fifth module configured to smooth the prepped projections in accordance with pre-selected thresholds;
a sixth module configured to determine final projections utilizing unsmoothed prepped projections and smoothed prepped projections; and
a seventh module configured to filter and backproject the final projections to generate an image of the object.

22. An apparatus in accordance with claim 21 wherein to produce temporary values, said second module is further configured to multiply said prepped projection values by a constant.

23. An apparatus in accordance with claim 21, wherein said fourth module is further configured to clip said SR factors to avoid logarithmic singularities.

24. An apparatus in accordance with claim 21 wherein to smooth the prepped projections in accordance with pre-selected thresholds, said fifth module is further configured to use different degrees of smoothing depending upon which of the pre-selected thresholds are triggered.

25. An apparatus in accordance with claim 21 wherein said smoothing comprises 3D smoothing.

26. An apparatus in accordance with claim 21 wherein said smoothing is directional.

27. An apparatus in accordance with claim 21 wherein said smoothing is adaptive.

28. An apparatus in accordance with claim 21 further comprising an eighth module configured to determine smoothing gain factors in accordance with a relative strength of the smoothed prepped projections.

29-34. (canceled)

35. A non-transitory computer storage medium comprising instructions thereon, said instructions configured to instruct a computer to:
produce temporary values utilizing projections acquired from a scan of an object, wherein said production of temporary values includes the production of prepped projections to a point prior to a logarithmic operation;
determine shading reduction (SR) factors as a function of the temporary values;
conditionally multiply the prepped projections using the SR factors;
smooth the prepped projections in accordance with pre-selected thresholds;
determine final projections utilizing unsmoothed prepped projections and smoothed prepped projections; and
filter and backproject the final projections to generate an image of the object.

36. A non-transitory computer storage medium in accordance with claim 35 wherein to produce temporary values, wherein said instructions are further configured to instruct the computer to multiply said prepped projection values by a constant.

37. A non-transitory computer storage medium in accordance with claim 35, wherein said instructions are further configured to instruct the computer to clip said SR factors to avoid logarithmic singularities.

38. A non-transitory computer storage medium in accordance with claim 35 wherein to smooth the prepped projections in accordance with pre-selected thresholds, said instructions are configured to instruct the computer to use different degrees of smoothing depending upon which of the pre-selected thresholds are triggered.

39. A non-transitory computer storage medium in accordance with claim 35 wherein said smoothing comprises 3D smoothing.

40. A non-transitory computer storage medium in accordance with claim 35 wherein said smoothing is directional.

41. A non-transitory computer storage medium in accordance with claim 35 wherein said smoothing is adaptive.

42. A non-transitory computer storage medium in accordance with claim 35, wherein said instructions are further configured to instruct the computer to determine smoothing gain factors in accordance with a relative strength of the smoothed prepped projections.
